(19) United States
(12) Patent Application Publication
(10) Pub. No.: US 2021/0117913 A1
(43) Pub. Date: Apr. 22, 2021

(54) SYSTEMS AND METHODS FOR PRESENTING AND DISPENSING PRODUCTS

(71) Applicant: Gilbert Villanueva, Round Rock, TX (US)

(72) Inventor: Gilbert Villanueva, Round Rock, TX (US)

(21) Appl. No.: 17/076,695

(22) Filed: Oct. 21, 2020

Related U.S. Application Data
(60) Provisional application No. 62/924,069, filed on Oct. 21, 2019.

(51) Int. Cl. G06Q 10/08; G06Q 30/06

(52) U.S. Cl. CPC G06Q 10/0832; G06Q 30/0637; B64C 39/024; G06Q 30/0623; G06Q 10/087

(57) ABSTRACT

A system for dispensing products from inventory includes a product inventory space housing an inventory of products, a product presentation space separate from the product inventory space, and one or more portable product interaction devices communicatively coupled to the product presentation devices. The product presentation space includes two or more product presentation devices. The portable product interaction devices are operable by customers in the product presentation space to control the at least one product presentation device to present, in the product presentation space, a representation of a product in inventory for the customer to view.

### PRIORITY CLAIM

This application claims priority to U.S. Provisional Patent Application No. 62/924,069, filed Oct. 21, 2019, entitled “Systems and Methods for Presenting and Dispensing Products”, which application is incorporated by reference as if fully set forth herein.

### BACKGROUND

### Field

The present invention relates to the field of product presentation and distribution. More specifically, embodiments herein relate to systems for presenting and dispensing products to retail customers.

### Description of the Related Art

Traditional retail stores acquire, arrange, and display a large number of items for sale. Each item displayed in the store is available for selection and purchase by customers visiting the store.

Traditional retail stores, whether in the form of a supermarket, clothing store, department store, electronics store, or otherwise, typically require a large amount of space to display all of the items. The sheer number of items, aisles, shelves, display bins can be overwhelming to customers. In addition, it may time consuming and frustrating for a customer to find, walk to, and select all of the items that customer is interested in. Moreover, there is often little or no standardization among retail stores as to how items are arranged—even in stores of the same type, such as between two different grocery stores, or two different clothing stores.

The need to have a large number of items in a retail space has other negative effects. For example, the inventory required for displayed stores has direct costs in terms of the size of the store, labor costs of maintaining inventory, and product waste. Also, stores with numerous items and large spaces may be more susceptible to shoplifting or other forms of theft.

The proliferation of products in recent years has sometimes made shopping a greater chore. A supermarket customer may, for example, have to scan over several shelves and dozens of brands of tortilla chips to find the particular brand and style of chip he or she wishes to buy.

### SUMMARY

Various embodiments of systems and methods for presenting products to customers and dispensing products to customers are described. In an embodiment, a system for dispensing products from inventory includes a product inventory space housing an inventory of products, a product presentation space separate from the product inventory space, and one or more portable product interaction devices communicatively coupled to the product presentation devices. The product presentation space includes two or more product presentation devices. The portable product interaction devices are operable by customers in the product presentation space to control the at least one product presentation device to present, in the product presentation space, a representation of a product in inventory for the customer to view.

In an embodiment, a method of dispensing products includes: generating a representation of a product in a product presentation space; receiving an order from a customer that has viewed the product representation while in the product presentation space; and dispensing a product from an inventory space that is separate from the product presentation space.

In an embodiment, a system for guiding customers in a product presentation space includes a customer guidance system and one or more portable product interaction devices. The customer guidance system has a guide control unit and one or more customer guide indicator devices The guide control unit receives information about a customer in the product presentation space from a portable product interaction device; and controls the customer guide indicator devices to provide a signal to the customer to guide the customer in the product presentation space. The signal is based at least in part on information about the customer received from the portable product interaction device.

In an embodiment, a method for guiding customers in a product presentation space includes: receiving information about a customer in the product presentation space from one or more portable devices accompanying or held by the customer; and generating, based at least in part on the information, a visual indicator to the customer to guide the customer to or from one or more production presentation stations within the product presentation space.

In an embodiment, a system for capturing information for a customer about apparel includes a booth having a floor for a customer to stand while trying on an item of apparel; two or more mirrors arrayed around the floor of the booth; one or more cameras configured to capture images of the customer as the customer wears the item of apparel in the booth; and a control unit configured to transmit images and information about the item of apparel to an electronic device operated by the customer.

### BRIEF DESCRIPTION OF THE DRAWINGS

FIG. 1 illustrates one embodiment of a system for presenting and dispensing products to customers.

FIG. 2 illustrates one embodiment of a system including illumination guiding to interest areas.

FIG. 3 illustrates one embodiment of a system including guide indicator signs to interest areas.

FIG. 4 illustrates one embodiment of a retail space management system.

FIG. 5 illustrates one embodiment of a product presentation station.

FIG. 6 illustrates one embodiment of a smart mirror system.

FIG. 7 is a block diagram illustrating one embodiment of a system that provides for delivery of products to a centralized customer pickup location.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF ILLUSTRATIVE EMBODIMENTS

In various embodiments, systems and methods for presenting products to customers and dispensing products to customers are described. Systems as described herein may be used in retail establishments or any other places where products or other items are sold or distributed. Examples of retail establishments in which systems may be employed includes markets, supermarkets, boutique shops, flower shops, electronic stores, restaurants, hardware stores, and department stores.

In various embodiments, products for purchase are placed in the back of a store, out of sight or reach for the customer so that the front of the store will be predominately for display, or display only. Product displays may be in the form of, or produced by, a physical item, digital image, augmented reality (“AR”), virtual reality (“VR”), mixed reality (“MR”), holographic, touchscreen, or a manufacturer's representative with an interactive display. The product displays may provide detailed information about products.

Customers may have a store-issued smart device to scan displayed items for detailed information or to add to their check-out cart. Customers can also use an app on their personal smart device to add items to their cart. Customers can use store issued devices or personal smart devices to get more information of displayed items via text, email, social media, or link that is transmitted between display items to smart devices. Information may be extracted from a small or large screen and/or from one or more different forms of reality.

In one embodiment, a system includes a product presentation space, an inventory space, and one or more product dispensing devices. At least some of the inventory space is separate from the presentation space. The inventory space may be adjacent to the product presentation space. An example of a presentation space includes a product display room. In some embodiments, system 100 is provided as a retail store for products to be acquired by customers visiting the store.

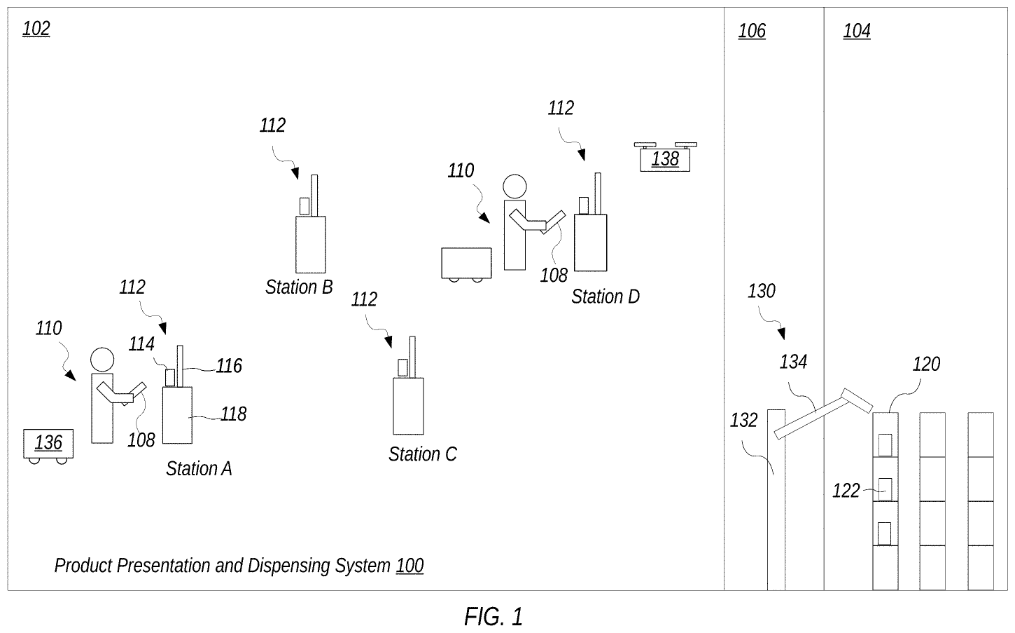

FIG. 1 illustrates one embodiment of a system for presenting and dispensing products to customers.

System 100 includes product presentation space 102, inventory space 104, dispensing space 106, and portable product interaction device 108. Each of customers 110 may receive a portable product interaction device 108. Customers 110 may use their portable product interaction device 110 to evaluate and select products for purchase.

Product presentation space 102 houses product presentation stations 112. Each product presentation station 112 may include a display of a representation of one or more products. Customers 110 using system 100 may visit any or all of product presentation stations 112 with their portable product interaction device 110. Examples of product presentation stations 112 include display screens, kiosks, booths, shelves, or platforms. Each of product presentation stations 112 includes product presentation device 116 and platform 118. Product presentation devices 116 may be, or produce, a representation of a product that can be acquired by the customer. Examples of a product presentation device include a screen display, holographic device, AR system, VR system, or MR system. In some embodiments, product representation is a tangible object, such as representative sample 114. In certain embodiments, a product presentation device is a unit of the product to be acquired. In some embodiments, the customer uses a viewing device (e.g., headset or special glasses) to view a product representation at a product presentation station.

Inventory space 104 may provide storage for items that can be purchased by customers 110. Inventory space 104 includes shelves 120. Products 122 may be held on shelves 120.

Dispensing space 106 may include product dispensing system 130. In the system shown in FIG. 1, dispensing system 130 includes picker machine 132 with robotic arm 134. In other embodiments, however, a dispensing system may include other mechanisms, systems, or devices for taking a product to be sold to a customer out of inventory. In one embodiment, a dispensing system includes a conveyor system.

Portable product interaction device 110 may be operatively connected (e.g., by wireless) to any or all of the product presentation devices 116. Various kiosks or displays with hologram, virtual reality, augmented reality, or mixed reality may be provided at the stations to provide customer service. The system may also provide alerts and notification for a live associate or customer service representative to assist.

In some embodiments, the customer may use a scanner, smart device, or an app on phone that can scan tags or codes on products. In one embodiment, one or all of these devices may be included, or serve as, a portable product interaction device. Scans may provide various options to the customer relating to purchase of items available at an establishment. For example, scans may alert the establishment or associate of which product(s) including size, color, and style the customer has chosen to hold at checkout counter for purchase or to hold, for example, at a dressing room. The scans may provide customer with detailed information about product and company information, and/or provide online price comparisons. Scans may schedule an email, alerts, or notifications about the product such as when it goes on sale, is marked to discontinue from designer/company brand, how well the product has been selling, or a timeline of when a product will be pulled from establishment's inventory.

In some embodiments, stationary or mobile display shelves, racks, or compartments that hold retail products will project information via hologram, VR, AR, MR, or on digital screen about products that are available for purchase. For example, product displays at a garment store may provide information on which label/designer brands the garment store is currently housing. Rack, shelves, and compartments will also project information about the establishment's current product promotions or upcoming events/promotions.

In some establishments using systems such as described herein, sitting or consultation areas are provided where customers can sit and speak with employees or representatives to provide more information about products, upcoming products, promotions or discuss past discrepancies that customers had with products so they can provide a resolution.

In certain embodiments, a system implements a price structure based on size. For example, smaller sized garments or attire may be less expensive that larger sized attire.

Automated Shopping Assistants

In some embodiments, a system for presenting and dispensing products includes an automated or autonomous cart follow the customer as they shop. In FIG. 1, for example, each customer may be accompanied by autonomous cart 136. Autonomous cart 136 may include various compartments to hold drinks, smart devices, and outlets to charge devices. In certain embodiments, the cart includes temperature-controlled compartments for storage.

In some embodiments, the system may include one or more drones. In FIG. 1, for example, drones 138 may provide assistance to any of the customers. Customers may have the option to have drones follow the customers around to give information, critique garments/merchandise, alert customer support associates, provide music, or act as personal shopper via Skype or similar connection.

Fulfillment

Customers' purchases may be fulfilled by employees or an automated system. In some embodiments, dispensing of products may be accomplished at the back of the store. Orders may be bagged, boxed, or packaged and ready for pick up after customer has completed shopping and paid in full. Each customer may also have the option to have his or her order delivered if the customer does not want to take their purchase order at that time.

In some embodiments, a system includes will have carousel system, conveyer belt, or automated cart in place to have products dispatched to customer. As an example, a customer can choose or schedule products to be transported to customers' location within establishment or to dressing room by employee, carrousel, conveyer, or automated cart. Customer can choose or schedule the dispatch from phone, customer associate, or store issued smart device, and scanners.

Customers may also schedule a time to have garments delivered at a specified time frame to desired address after purchasing merchandise. Customers may also have the option to have a rented autonomous vehicle deliver their products at a scheduled time.

In some embodiments, a system includes a return system that can accept deliveries from an autonomous vehicle in a specified area. The specified area may be also be used for returns, exchanges, and dropping off recyclable bags or reusable containers. The system may also include an in-house depot or drop off area for recyclable/reusable containers that that can utilized by the establishment or by establishments' partners/contractors.

Attribute Selection

In some embodiments, a customer selects attributes of a product representation that is available at a product presentation station. For example, using the customer's portable product interaction device, the customer may request that a product presentation device change the color, size, shape, or design of product. In one embodiment, the customer selects a product attribute using the customer's portable product interaction device. An instruction may be sent from the portable product interaction device to the product presentation device (e.g., display screen, holographic projector) to regenerate the product representation to reflect the selected attributes. Numerous other product attributes that may be selected by a customer. Examples include texture, scent (e.g., for perfume), flavor, weight, material, resolution (e.g., for televisions), horsepower, or electrical power output.

In some embodiments, a customer changes attributes of a tangible product representation in a product presentation space. For example, the customer may be provided with a tangible product representation of a golf club having adjustable length. The customer may physically adjust the length of the golf club to a desired length. The system may automatically capture the selected length to enable the customer to order a club having the selected length from the inventory space.

In an embodiment, a smart device that will project a retailer's or manufacturer's products with detailed information of product(s). Projection of a product image may be accomplished by AR, MR, VR, or hologram. Projected items may provide information of sellers or price and how to order products. A customer's portable device may be updated by way of a wireless connection, such as Bluetooth or Wi-Fi connection. In certain embodiments, retailers or manufactures sell or lease the smart devices.

In some embodiments, a product is displayed with information showing all of its functions and capabilities on demand or by a sensor initiating the display.

In some embodiments, one product is provided on shelf for display only. The display product may be scanned. An employee, android, or robot in back of store may collect item for customer. Once all items are collected, the items may be bagged, boxed, or packaged and ready for customer after they have paid. The customer may be provided with the option to have their items for pick up or delivery after paying.

In some embodiments, a system includes a digital or personal display for products such as a demo screen, holograms, VR, AR, or MR displays for products. The customer may interact with displays to educate customers or speak with customer service about product.

Customers Shopping History

In some embodiments, a system provides shopping history via a portable device. The customer may be provided data ranging from, for example, how much volume the customer purchases to what products the customer can save money on by switching brands. The data may also include information on brands or the manufacturers. The system may provide information for customer to inform them about what they can afford for the day, week, or month by inputting budget and retailer can provide what items are affordable for that budget.

Customer Guidance/Highlighting

In some embodiments, a system for presenting products (e.g., in a retail store) includes guiding indicators. The guiding indicators may guide or direct each customer to specific stations or areas in a store based on the customer's shopping preferences or needs.

In one embodiment, different areas of an establishment illuminate or highlight a number/color to indicate where customers attention is required for desired products. The establishment will also have the option for customers to synch up their personal shopping data via smart device so that their past shopping and viewing patterns are accessed by the establishment so that specific items or areas of the store are highlighted or illuminated for customers. Areas of interest for the customer may be highlighted by some form or fashion to guide the customer's attention to the areas of interest, and to avoid the areas of non-interest to the customer. In one embodiment, illumination is provided by lighting a station or sign of interest to the customer. As the customer advances through a product presentation space and completes product evaluation/shopping in one area or station, the system may illuminate another area of interest to the customer. In some embodiments, customers are released into the retail space sequentially and/or to different stations of the space in a coordinated manner.

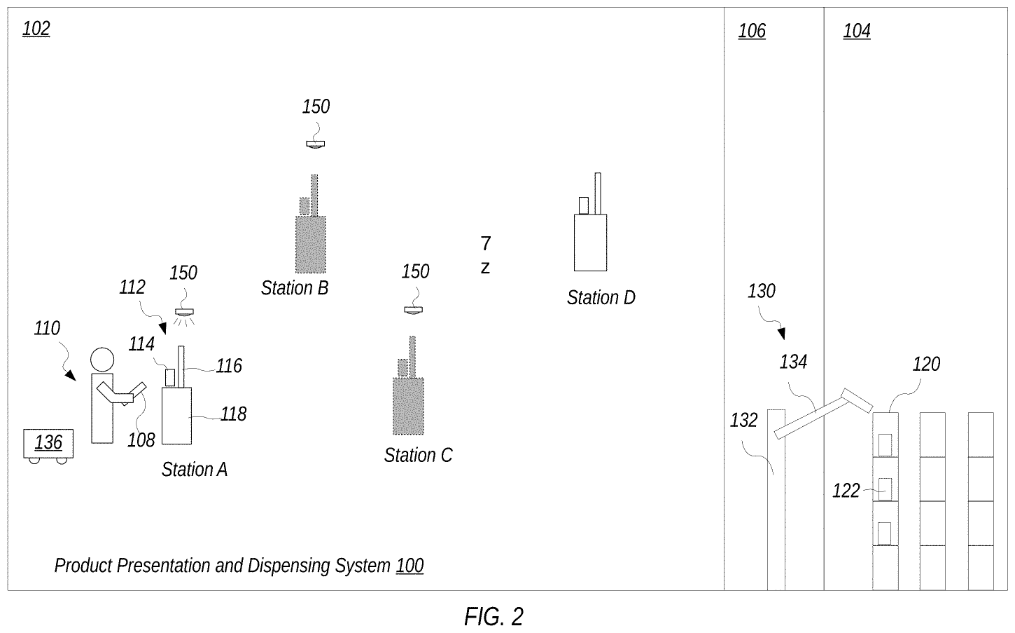

FIG. 2 illustrates one embodiment of a system including illumination guiding to interest areas. Downlights 140 are provided at each of product presentation stations A, B, C, and D. The downlights 140 may turn on the indicators for areas of interest for the customer. The areas of interest for each customer may be selected based on information for that customer's account, information about the current visit by the customer, and/or information provided by the customer during the shopping experience. In FIG. 2, for example, downlights 140 are turned on at product presentation stations A and D to guide the customer to those stations. In contrast, downlights 140 at product presentation stations B and C are left off, so those stations are not illuminated because they are not of interest to the customer.

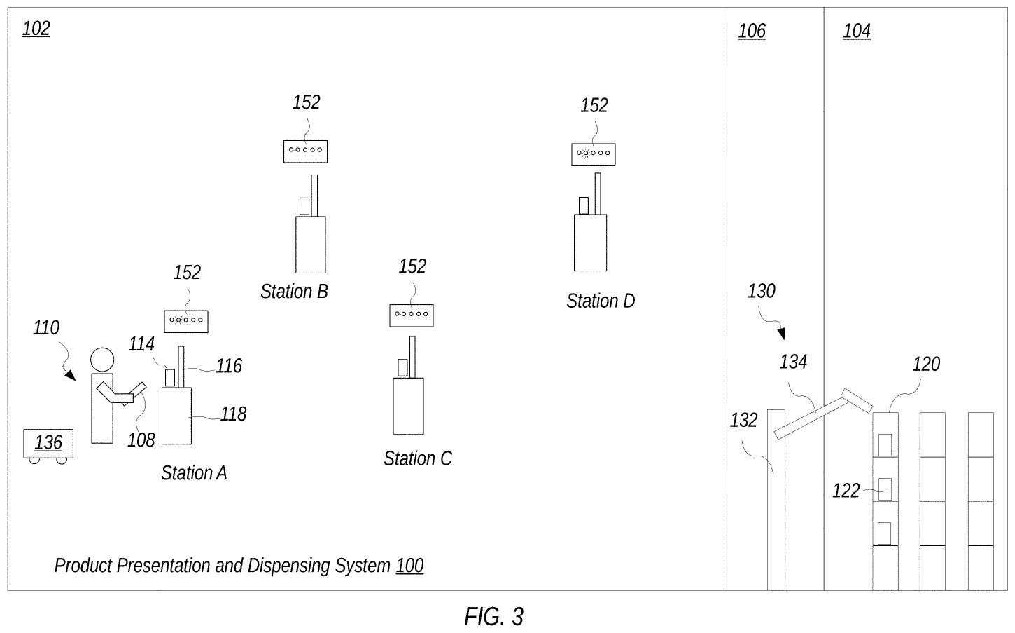

FIG. 3 illustrates one embodiment of a system including guide indicator signs to interest areas. Guide indicator panel 142 are provided at each of product presentation stations A, B, C, and D. Each customer may be associated with an indicator for that customer, such as a particular color or symbol. For example, one customer may be assigned to a red indicator, another customer assigned to a purple indicator, and another customer to a blue indicator. Each indicator sign may turn on the indicators for the customer interested in that area. The indicators for each customer may be selected based on information for that customer's account, information about the current visit by the customer, and/or information provided by the customer during the shopping experience. In FIG. 3, for example, a purple indicator light may be illuminated on guide indicator panels 142 at product presentation stations A and D, but the purple indicator lights are not illuminated on the panels at product presentation stations B and C. In this manner, each area of interest for a given customer may be highlighted for that customer.

In some embodiments, a customer guidance system is provided in the form of a map or list on the customer's portable product interface device, mobile phone app, or other portable system.

In some embodiments, a customer flow management system uses information collected from multiple customer devices and/or in the customer accounts to guide traffic by various customers through a retail space in a coordinated fashion. Guidance for the customer based on information for those customers' accounts, information about the current visit by the customer, and/or information provided by the customer (e.g., from the customers' handheld devices) during the customers' shopping experiences. The system may guide the various customers based on various needs or goals for the store. For example, if data from the customers' handheld devices indicates that there is a bottleneck in the sports wear section of a supermarket, the system may use guide indicators to direct newly arriving customers to the shoes or business casual areas of the store until traffic in the sports wear area has subsided. As another example, the system may guide customers to products being promoted on that particular day. The guidance may be based, for example, on keeping a target level of traffic in a particular area of the store or at specific product presentation stations.

### Product Presentation and Dispensing System—Example

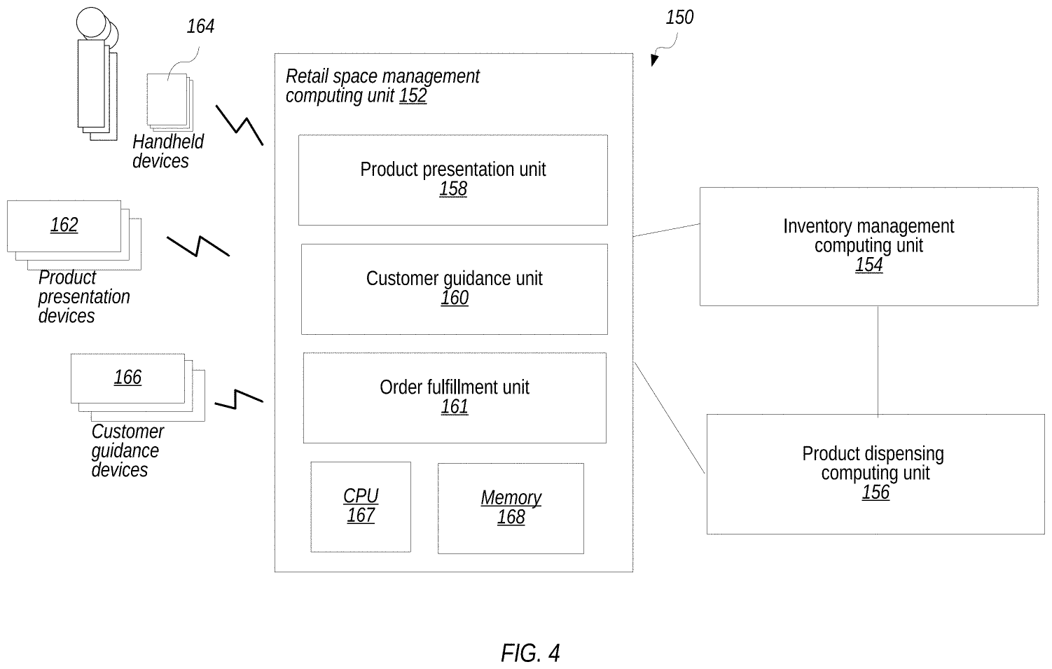

FIG. 4 illustrates one embodiment of a retail space management system. Retail management system 150 includes computing devices, display devices, and customer assistance systems connected over a communication network. Retail space management computing unit 152 is coupled to inventory management computing unit 154 and product dispensing computing unit 156. Retail space management unit 152 includes product presentation control unit 158, customer guidance unit 160, and order fulfillment unit 161. Retail space management computing unit 152 also includes CPU 167 and memory 168. CPU 167 may perform computations for any or all of product presentation control unit 158, customer guidance unit 160, and order fulfillment unit 161. Product presentation control unit 158 is coupled to product presentation devices 162 and handheld customer devices 164. Product presentation devices 162 may be provided at, for example, various product presentation stations in a retail store. Product presentation control unit 158 and customer guidance unit 160 may be communicatively coupled to handheld customer devices 164. Handheld customer devices may be, in some embodiments, portable product interaction devices, such as described above relative to FIG. 1.

Customer guidance unit 160 may control customer guidance indicator devices 166. Customer guidance indicator devices 166 may be, for example, downlights as described above relative to FIG. 2 or guide indicator panels such as described above relative to FIG. 3.

Computing units, as described herein, may be implemented in the form of computer systems, computing devices, or combinations thereof. In various embodiments, some of the computing units described above with respect to FIG. 4 may be combined in to one computing unit, or separated into two or more computing units. For example, product presentation control unit 158 and customer guidance unit 160 may be combined into one computing unit. Devices as described herein may be connected to one another by wires, optical cables, or any of various wireless technology, such as Wi-Fi, Bluetooth, or Near Field Communication.

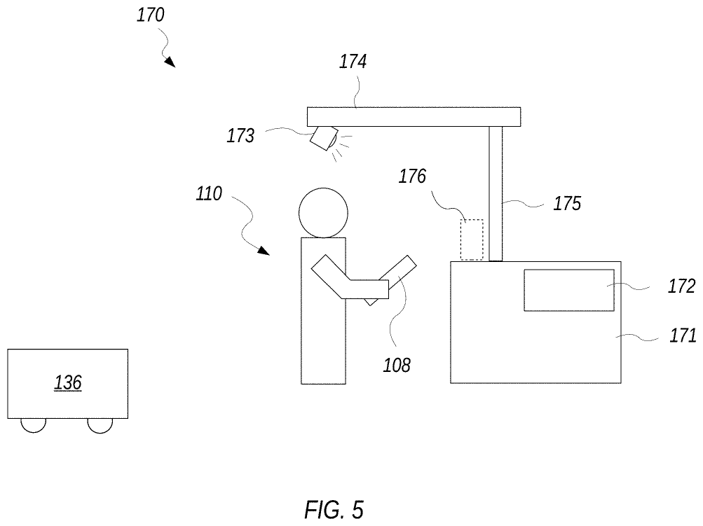

FIG. 5 illustrates one embodiment of a product presentation station. Product presentation station 170 includes platform 171, product presentation control unit 172, and product image projector 173. Product image projector 174 mounted on boom 174, which is in turn mounted to platform 171 by way of post 175. Product image projector 173 may be communicatively coupled to product presentation control unit 173. Product image projector 173 may receive information from product presentation control unit 172 to generate a product image 176. Product image 176 may be, for example. a holographic image, or an image projected on a flat screen or curved screen. Product image projector 173 may project a product image based on the information received from product presentation control unit 173. Customer 110 may provide input to product presentation unit 171 using portable product interaction device 108. As noted above, in some embodiments, a product representation may be in form of a tangible object (e.g., a product sample) resting on platform 171.

The position and orientation of product image projector 174 may be adjustable relative to platform 171. Various adjustment mechanisms (e.g., hinges, ball-joints, linkages) on or between the mounting elements.

Apparel

In some embodiments, display samples are provided for customers to view and try on to record measurements. Customers have the option to purchase any article of clothing after their measurements have been taken. Customers can request a line of clothing from a specific designer to be shipped to the establishment to come in for fitting on a scheduled time frame. Customers may view an interactive display of designer's line of clothing if not available at store location. For example: customer can choose any article of clothing from an online catalog and view the how well the clothing would fit on a digital display using the customer's measurements.

In some embodiments, a system includes mirror system. As used herein, “smart mirror system” includes any system, apparatus, device, or combinations thereof, that allows a customer to view himself or herself while trying on apparel.

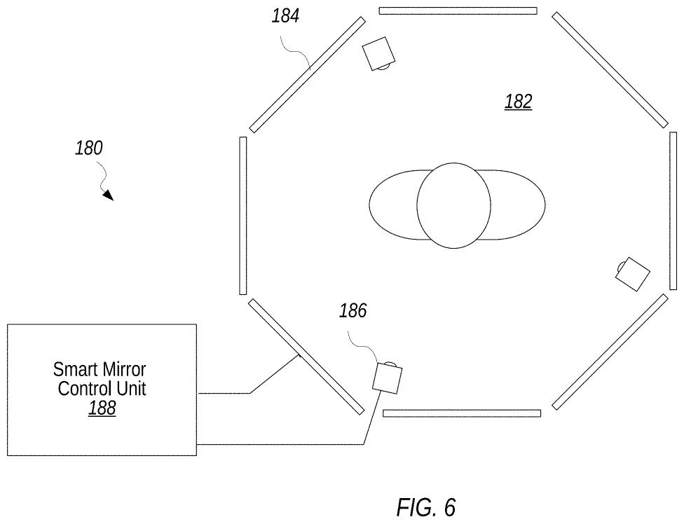

FIG. 6 illustrates one embodiment of a smart mirror system. Smart mirror system 180 includes booth 182, mirrors 184, cameras 186, and smart mirror control unit 188. Smart mirror control unit 188 may control cameras and/or mirrors to take capture images of the customer wearing apparel in the smart mirror booth. Smart mirror control unit 188 may be communicatively coupled (for example, via a network) to a customer's product presentation interaction device, an app on the customer's phone, or to the store computer system. Any or all of mirrors 184 and cameras 186 may be provide on mechanisms to allow the cameras or mirrors to be pointed in desired directions or angles relative to booth 182.

Customers may utilize smart mirror system to get full 360 view of the garments worn by the customer. A customer may also have the option to have photos taken by the mirror system sent to them by email, SMS, or social media. Customer can use finger print scan, security pin, password, voicemail recognition, or facial recognition for security to send and view photos.

The customer may also be able to view same garments sold online from either the display rack, shelves, compartments or from smart mirror(s) for price comparison shopping. The Customer can view online ratings. All this information can be forwarded to the customer by text, email, or social media.

In some embodiments, a system enables a customer to view specific garments or article of clothing through AR, MR, VR, hologram, or projection. The customer may be able to view several different garments from the same or different designer/clothing companies to make or assemble outfit(s). This can include accessories, shoes, and jewelry. In certain embodiments, a system includes a digital display of an actor or model wearing an article of clothing that a retail store is selling or promoting.

Food Waste Management

In some embodiments, an establishment, such as a supermarket, uses foods in its inventory to supply on-site food classes, camps, or schools for students/participants to use in addition to fresher foods. In this manner, discarding of expired foods may be reduced. Students/participants may prep or cook foods utilizing in-house commercial kitchen(s) but can also serve prepared meals to customers who want to consume foods after deemed acceptable by chef, teacher, or instructor. A dedicated service may be provided for the purpose of preventing or reducing food waste in conjunction with continuous educational services for students/participants.

The commercial kitchen(s) may also be used by contractors, suppliers, manufacturers or partners to assemble or create their products by sourcing local or in-house ingredients to cut back on outsourcing ingredients and instead utilize the establishments' inventory. “TV dinner” and meal kit companies may use the establishments' products with little to no outside ingredients to be included in their meals sold to customers, with the goal of providing fresher and/or non-frozen ingredients used in their final product.

Electronics

In some embodiments, an establishment has the option to sell extended warranty on products that customer purchased online instead of at the physical establishment. For example, a customer may see an online price on display next to the physical item, chooses to purchase the online item instead using the retailers POS, but purchases a warranty on the product from the manufacturer.

Recyclable Stores/Kiosks for Travel Products:

To cut back on plastic waste for travel products, stores may sell travel related products, such as shampoo, soap, lotion, toothpaste, contact solutions, drinks, foods, cosmetics, etc. In some cases, a store may sell exclusively or primarily travel-related products. Products may be sold in reusable travel-sized containers.

In one embodiment, a stand-alone kiosk or vending machine dispenses and accept approved recyclable and reusable glass/plastics for travel products. Glass/plastics containers will be accepted so that can be cleaned, sanitized, and refilled. Customers may receive a partial refund or credit towards a new travel product if they return store issued used containers. Stores may be provided in partnerships with hotels, hostels, airports, bus stations, train stations, and apartments that have drop-off kiosks or depots.

Pharmacy

In some embodiments, a pharmacy has customer suites and lounge areas. Suites may be in the form of small offices or booths where customers can wait and have the privacy to speak or consultant with pharmacist/doctors. Suites may also be available for customers to meet with pharmaceutical reps who can offer information about their specific products so customers can ask their doctors for prescriptions. Lounge areas may be for customer waiting for their prescription but also offer digital displays via a phone app, AR, VR, MR, or smart device, of the products offered at these pharmacies for purchase that will also be gathered and bagged for customers so that all products will be ready for customer at check out. Customer may also have the option to purchase their product(s) and schedule to have it delivered by a safe and secure mode of transportation, at a desired time frame.

Grocery Store:

In some embodiments, in addition to the digital display of a product for sale itself, the system displays what dishes (appetizers, entrees, desserts, etc.) a food product or ingredient is used or included in. Digital displays may include actors, celebrities, or any influential character (real or animated) selling or promoting the product. In one embodiment, video is provided of a chef describing a food product as the chef is adding it to a dish the chef is cooking or baking.

Store Sign Displays

In some embodiments, a system includes a digital display of the store name or logo on or around their physical location. The size and colors of the sign may be altered or changed.

Embedded Product Chip

In some embodiments, a chip (e.g., RFID device) is embedded into a product for sale. A chip may be embedded in any of various items such as, furniture, clothing, books, electronics. A consumer (either while in the retail store or post-purchase) may use a scanning device to scan the chip. The chip may provide the customer with information regarding the product, including where to purchase the product with links or company information. The chip may contain an authentication code or link information to the manufacturer to verify product is a not counterfeit when scanned with smart device.

Centralized Product Pickup

In an embodiment, a method for dispensing products to customers includes electronically receiving orders from a customer for items at two or more stores. The stores may be in the same retail facility, such as a shopping mall. The system may provide for internal delivery of products within the facility for a customer to purchases from multiple stores within the facility. After the customer make in-store purchases of each product, the system dispenses the product from the store of purchase and delivers the product to a centralized location where products purchased by the customer from the stores can be picked up by the customer. The centralized location may be, for example, a locker or secured bin in a pickup room or pickup area. As used herein, “centralized” includes having a single room, area, or zone in a facility for picking up products from multiple stores. “Centralized” is not limited, for example, to a location that is physically in the center of a mall or other facility. For example, the centralized pickup location may be at the front, side, or back of a mall.

In some embodiments, one or more of the stores includes a system for presenting and dispensing products such as described above relative to FIGS. 1 through 6. Stores may include a product inventory space and a product presentation space separate from the product inventory space. Customers may use portable product interaction devices to evaluate products at product presentation stations within the product presentation space.

A customer may make a purchase at one store and have the option to have that purchase sent to a centralized location before moving on to another store. The customer's items may be stored in a compartment, such as a locker or secured bin, at the centralized location. After the customer is finished shopping, the customer may collect all the customer's purchases at the centralized or pick up location.

In some embodiments, the facility is an indoor mall with multiple retail stores within the interior of the mall. The centralized location may also be located within the interior space. In certain embodiments, a system may serve multiple stores in an outdoor setting. In certain embodiments, a system includes a customer guidance system such as described above relative to FIGS. 2 and 3. Guide indicators may be provided for intra-store guidance, inter-store guidance, or both. For example, the customer may receive a visual indicator (e.g., colored light) to indicate the next store in the customer's shopping excursion. In some embodiments, products are delivered from various stores to the centralized location using robots or auto-carts. In certain embodiments, products may be delivered to the centralized location by way of a conveyor system. The dispensing system may include one or more computing units that manage orders and product delivery to the centralized location.

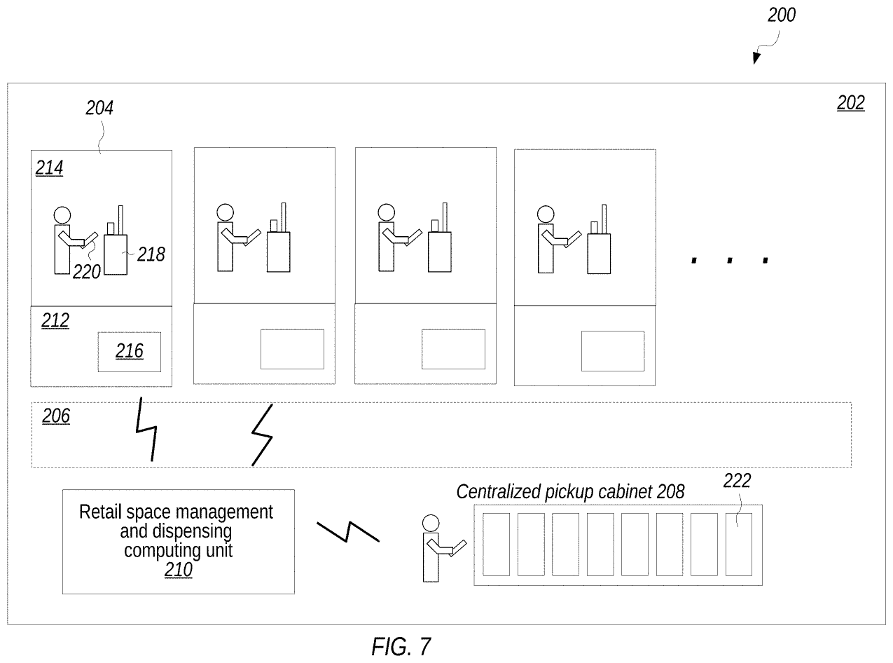

FIG. 7 is a block diagram illustrating one embodiment of a system that provides for delivery of products to a centralized customer pickup location. System 200 includes mall 202. Mall 202 includes stores 204, interconnecting hallway 206, centralized pickup cabinet 208 in a centralized pickup zone, and retail space management and dispensing computing unit 210. Stores 204 may each include product inventory space 212 and product presentation space 214. Product inventory space 212 may include product dispensing units 216. Product presentation space 214 may include product presentation stations 218. Customers may interact at product presentation stations 218, place orders for delivery via retail space management and dispensing computing unit 210 using portable product interaction devices 220. Centralized pickup cabinet 208 includes lockers 222.

Retail space management and dispensing computing unit 210, product dispensing units 216, product presentation stations 218, and portable product interaction devices 220 may be communicatively coupled with one another (e.g., by way of a wireless connection.

In some embodiments, a system for delivering products includes security devices for controlling customer pickup of the products. The security devices may also protect the items from being taken or stolen by other persons. Compartment in which various customers products are held may, for example, include locks to control access to the compartment. A computing device may operate each lock to control whether the compartment can be accessed. For example, the system may keep a compartment locked until a customer electronically verifies the customer's identity and/or that the products held in the compartment have been paid for.

In some embodiments, one or more security protocols are used to control access to a compartment in which purchased items are held for the customer at the centralized location. In one embodiment, biometric authentication is used to verify the identity of a purchaser before allowing access to a compartment. Biometric authentication may include facial recognition, fingerprint recognition, hand geometry biometrics, retina scan, iris scan, signature analysis, and/or voice analysis. In some embodiments, a customer accesses the compartment using a mobile phone or other portable electronic device. Biometric authentication systems may be built into the compartments. A combination of both purchaser devices and delivery system devices may be used to verify the identity of the purchaser. In certain embodiments, an employee may verify and retrieve purchases at the pickup location.

In some embodiments, the system may allow a customer to make a payment at the centralized location. If the customer has not already paid for all of the products in the compartment, for example, the system may require payment by the customer prior to the customer receiving access to the compartment in which the customer's items are being held. In some embodiments, the system accepts electronic forms of payment. Electronic forms of payment may include Apple pay, Samsung pay, online payment (e.g., computer website, cellphone application, etc.) In some embodiments, the case of electronic payments, a customer may receive a verification code to key into their designated compartment. Upon removal of the purchased items from the designated compartment, that compartment may no longer be available until items purchased by another customer have been delivered to the compartment.

Although in the embodiment shown in FIG. 7, a centralized location for pickup of multiple stores is used in the context of stores including separate product presentation space and product inventory space, a centralized location for pickup may, in some embodiments, be used in stores that do not have separate spaces for product presentation and product inventory.

As used herein, “space” includes a room, booth, container or other space, or combination thereof, in which products can be presented, stored, dispensed, transferred, selected, or processed. A space may be formed by a floor, walls, barriers, columns, screens, or various other structural elements, or combinations thereof. In some embodiments, a space is an open space.

As used herein, a “presentation space” includes a space in which products can be presented, evaluated, examined, tried, or tried on.

As used herein, a “inventory space” includes a space in which products can be held in inventory.

As used herein, “presenting” includes showing an item or representation of an item and/or making the item or a representation of the item available for inspection.

As used herein, “dispensing” includes giving out or distributing something or making it available for someone to pick up. Dispensing can be in connection with a purchase by a customer of the item being dispensed.

In certain embodiments, a retailer or manufacturer may provide a smart device that projects that retailer or manufacturer's products through AR, MR, VR, or Hologram. The AR, MR, VR, or Hologram may present detailed information of product(s). The projected items may include display of information of sellers or price and how to order products.

Computer systems and computing devices may, in various embodiments, include components such as a CPU with an associated memory medium such as a solid-state storage device or Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems and computing devices may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, television system or other device. In general, the term “computer system” or “computing device” may refer to any device having a at least one processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

A computing system may include, and/or may be implemented as, multiple functional modules or components, with each module or component including one or more resources (e.g., computing resources, storage resources, database resources, etc.). A system may include more or fewer components or modules, and a given module or component may be subdivided into two or more sub-modules or subcomponents. Also, two or more of the modules or components can be combined.
Some embodiments are set forth in the following clauses:
A1. A system for dispensing products from inventory, comprising:
a product inventory space housing an inventory of products;
a product presentation space separate from the product inventory space, the product presentation space comprising two or more product presentation devices; and
one or more portable product interaction devices communicatively coupled to at least one of the product presentation devices, wherein at least one of the portable product interaction devices is operable by a customer in the product presentation space to control the at least one product presentation device to present, in the product presentation space, a representation of a product in inventory for the customer to view.
A2. The system for dispensing products from inventory of clause A1, wherein the handheld product interaction device is operable by the customer to place an order for a product viewed by the customer.
A3. The system for dispensing products from inventory of clause A1, further comprising an order fulfillment system, wherein the order fulfillment system is configurable to fulfill an order for a product placed by the customer using the portable product interaction device.
A4. The system for dispensing products from inventory of clause A1, further comprising a product dispensing system, wherein the product dispensing system is configurable to dispense a product from the inventor space in response to an order placed by the customer using the portable product interaction device.
A5. The system for dispensing products from inventory of clause A1, wherein the portable product interaction device comprises a smart phone.
A6. The system for dispensing products from inventory of clause A1, wherein at least one of the product presentation devices comprises a display device configurable to generate a representation of a product on the display screen in response to an operation performed by the customer on a portable product interaction device.
A7. The system for dispensing products from inventory of clause A1, wherein at least one of the product presentation devices comprises a virtual reality device configurable to generate a representation of a product in a virtual reality in response to an operation performed by the customer on a portable product interaction device.
A8. The system for dispensing products from inventory of clause A1, wherein at least one of the product presentation devices comprises a tangible object representation of a product in inventory.
A9. The system for dispensing products from inventory of clause A1, wherein at least one of the product presentation devices comprises a holographic generator configurable to generate a holographic representation of a product in response to an operation performed by the customer on a portable product interaction device.
A10. The system for dispensing products from inventory of clause A1, wherein at least one of the product presentation devices is configured to change an attribute in a representation of a product in response to an operation performed by the customer on a portable product interaction device.
A11. The system for dispensing products from inventory of clause A1, wherein at least one of the product presentation devices comprises a tangible object representation of a product in inventory.
A12. The system for dispensing products from inventory of clause A1, further comprising an autocart in the product presentation space configured to assist customers in reviewing products.
A13. The system for dispensing products from inventory of clause A1, further comprising a drone in the product presentation space configured to assist customers in reviewing products.
A14. The system for dispensing products from inventory of clause A1, further comprising a drone in the product presentation space configured to assist customers in reviewing products.
A15. The system for dispensing products from inventory of clause A1, wherein at least one of the product presentation devices is configured to present two or more different articles of apparel.
A16. The system for dispensing products from inventory of clause A1, wherein at least one of the product presentation devices is configured to present two or more different articles of apparel in combination with one another.
A17. The system for dispensing products from inventory of clause A1, further comprising one or more computing devices configured to:
receive shopping history information for one or more customers; and
transmit the shopping history information to a customer via at least one of the portable product interaction devices.
A18. The system for dispensing products from inventory of clause A1, further comprising one or more computing devices configured to:
generate use information for at least one of the products available to at least one of the customers in the product presentation space; and
transmit the use information to a customer via at least one of the portable product interaction devices.
A19. The system for dispensing products from inventory of clause A18, wherein the at least one product is a food product, wherein the use information comprises information on how to use the food product in one or more dishes.
A20. The system for dispensing products from inventory of clause A1, wherein at least one of the products available for purchase in the product presentation space comprises an embedded chip, wherein the embedded chip is scannable by an electronic device to obtain information about the product.
B1. A method of dispensing products, comprising:
generating a representation of a product in a product presentation space,
receiving an order from a customer that has viewed the product representation while in the product presentation space; and
dispensing a product from an inventory space that is separate from the product presentation space.
C1. A non-transitory, computer-readable comprising program instructions stored thereon that when executed on one or more computers cause the one or more computers to implement:
generating a representation of a product in a product presentation space,
receiving an order from a customer that has viewed the product representation while in the product presentation space; and
dispensing a product from an inventory space that is separate from the product presentation space.
D1. A system for guiding customers in a product presentation space, comprising:
a customer guidance system comprising a guide control unit and one or more customer guide indicator devices; and
one or more portable product interaction devices in the product presentation space and communicatively coupled to the guidance system,
wherein guide control unit is configured to:
   receive information about a customer in the product presentation space from at least one of the portable product interaction devices; and
   control at least one of the customer guide indicator devices to provide a signal to the customer to guide the customer in the product presentation space,
   wherein the signal is based at least in part on information about the customer received from the portable product interaction device.
D2. The system for guiding customers in a product presentation space of clause D1, wherein at least one of the guide indicators is a light configured to illuminate a product presentation station.
D3. The system for guiding customers in a product presentation space of clause D1, wherein the portable product interaction device is operable by a customer in the product presentation space to control at least at least one product presentation device to present, in the product presentation space, a representation of a product in inventory for the customer to view.
D4. The system for guiding customers in a product presentation space of clause D1, further comprising an order fulfillment system, wherein the order fulfillment system is configurable to fulfill an order for a product placed by the customer using the portable product interaction device.
D5. The system for guiding customers in a product presentation space of clause D1, further comprising a product dispensing system, wherein the product dispensing system is configurable to dispense a product from the inventor space in response to an order placed by the customer using the portable product interaction device.
E1. A method for guiding customers in a product presentation space, comprising:
receiving information about a customer in the product presentation space from one or more portable devices accompanying or held by the customer; and
generating, based at least in part on the information, a visual indicator to the customer to guide the customer to or from one or more production presentation stations within the product presentation space.
F1. A system for capturing information for a customer about apparel, comprising:
a booth comprising a floor for a customer to stand while trying on an item of apparel;
two or more mirrors arrayed around the floor of the booth;
one or more cameras configured to capture images of the customer as the customer wears the item of apparel in the booth; and
a control unit configured to transmit images and information about the item of apparel to an electronic device operated by the customer.
G1. A system for dispensing products at a multi-store facility, comprising:
a computing unit configured to receive orders from a customer at two or more stores in the facility; and
a centralized location in the facility configured to securely receive products ordered by the customer and dispensed from at least two of the stores to a single location for the customer.
G2. The system for dispensing products at a multi-store facility of clause G1, wherein the multi-store facility is a mall.
G3. The system for dispensing products at a multi-store facility of clause G1, wherein the centralized location comprises one or more containers configured to securely hold products ordered by the customer.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

What is claimed is:

1. A system for dispensing products from inventory, comprising:
a product inventory space housing an inventory of products;
a product presentation space separate from the product inventory space, the product presentation space comprising two or more product presentation devices; and
one or more portable product interaction devices communicatively coupled to at least one of the product presentation devices, wherein at least one of the portable product interaction devices is operable by a customer in the product presentation space to control the at least one product presentation device to present, in the product presentation space, a representation of a product in inventory for the customer to view.

2. The system for dispensing products from inventory of claim 1, wherein the handheld product interaction device is operable by the customer to place an order for a product viewed by the customer.

3. The system for dispensing products from inventory of claim 1, further comprising an order fulfillment system, wherein the order fulfillment system is configurable to fulfill an order for a product placed by the customer using the portable product interaction device.

4. The system for dispensing products from inventory of claim 1, further comprising a product dispensing system, wherein the product dispensing system is configurable to dispense a product from the inventor space in response to an order placed by the customer using the portable product interaction device.

5. The system for dispensing products from inventory of claim 1, wherein the portable product interaction device comprises a smart phone.

6. The system for dispensing products from inventory of claim 1, wherein at least one of the product presentation devices comprises a display device configurable to generate a representation of a product on the display screen in response to an operation performed by the customer on a portable product interaction device.

7. The system for dispensing products from inventory of claim 1, wherein at least one of the product presentation devices comprises a virtual reality device configurable to generate a representation of a product in a virtual reality in response to an operation performed by the customer on a portable product interaction device.

8. The system for dispensing products from inventory of claim 1, wherein at least one of the product presentation devices comprises a tangible object representation of a product in inventory.

9. The system for dispensing products from inventory of claim 1, wherein at least one of the product presentation devices comprises a holographic generator configurable to generate a holographic representation of a product in response to an operation performed by the customer on a portable product interaction device.

10. The system for dispensing products from inventory of claim 1, wherein at least one of the product presentation devices is configured to change an attribute in a representation of a product in response to an operation performed by the customer on a portable product interaction device.

11. The system for dispensing products from inventory of claim 1, wherein at least one of the product presentation devices comprises a tangible object representation of a product in inventory.

12. The system for dispensing products from inventory of claim 1, further comprising an autocart in the product presentation space configured to assist customers in reviewing products.

13. The system for dispensing products from inventory of claim 1, further comprising a drone in the product presentation space configured to assist customers in reviewing products.

14. The system for dispensing products from inventory of claim 1, further comprising a drone in the product presentation space configured to assist customers in reviewing products.

15. The system for dispensing products from inventory of claim 1, wherein at least one of the product presentation devices is configured to present two or more different articles of apparel.

16. The system for dispensing products from inventory of claim 1, wherein at least one of the product presentation devices is configured to present two or more different articles of apparel in combination with one another.

17. The system for dispensing products from inventory of claim 1, further comprising one or more computing devices configured to:
receive shopping history information for one or more customers; and
transmit the shopping history information to a customer via at least one of the portable product interaction devices.

18. The system for dispensing products from inventory of claim 1, further comprising one or more computing devices configured to:
generate use information for at least one of the products available to at least one of the customers in the product presentation space; and
transmit the use information to a customer via at least one of the portable product interaction devices.

19. The system for dispensing products from inventory of claim 1, wherein at least one of the products available for purchase in the product presentation space comprises an embedded chip, wherein the embedded chip is scannable by an electronic device to obtain information about the product.

20. A method of dispensing products, comprising:
generating a representation of a product in a product presentation space,
receiving an order from a customer that has viewed the product representation while in the product presentation space; and
dispensing a product from an inventory space that is separate from the product presentation space.
